(19) United States
(12) Patent Application Publication
(10) Pub. No.: US 2026/0004970 A1
(43) Pub. Date: Jan. 1, 2026

(54) SOLID ELECTROLYTIC CAPACITOR AND METHOD FOR MANUFACTURING SAME

(71) Applicant: Panasonic Intellectual Property Management Co., Ltd., Osaka (JP)

(72) Inventors: JUNICHI KURITA, Osaka (JP); HONAMI NAWA, Shiga (JP); HIROMU KIMURA, Osaka (JP); SAORI UEDA, Osaka (JP)

(21) Appl. No.: 19/318,883

(22) Filed: Sep. 4, 2025

Related U.S. Application Data
(63) Continuation of application No. PCT/JP2024/008414, filed on Mar. 6, 2024.

(30) Foreign Application Priority Data
Mar. 24, 2023 (JP) 2023-048362

(51) Int. Cl. H01G 2/02; H01G 9/00; H01G 9/025; H01G 9/04; H01G 9/07; H01G 9/10

(52) U.S. Cl. CPC H01G 2/02; H01G 9/0029; H01G 9/025; H01G 9/07; H01G 9/10; H01G 2009/05

(57) ABSTRACT

A solid electrolytic capacitor includes: a capacitor element including an anode part and a cathode part; a substrate that supports the capacitor element; a sealing body that seals the capacitor element; a first external electrode electrically connected to the anode part; a second external electrode electrically connected to the cathode part; and an adhesive layer disposed between the capacitor element and a first surface of the substrate. At an interface between the first surface and the adhesive layer, a maximum height Rz1 of surface roughness of the first surface is 5 μm or more, and a maximum height Rz2 of surface roughness of the adhesive layer is 3 μm or more.

### BACKGROUND

### 1. Technical Field

The present disclosure relates to a solid electrolytic capacitor and a method for manufacturing the same.

### 2. Description of the Related Art

International Publication WO2021/112239 proposes “a solid electrolytic capacitor including: a rectangular parallelepiped resin molded body including an element multilayer body, an insulating substrate, and a sealing resin that seals a periphery of the element multilayer body; a first external electrode provided on a first end surface of the resin molded body; and a second external electrode provided on a second end surface of the resin molded body, in which in the element multilayer body, a first layer and a second layer are stacked, the first layer includes a valve metal base body including a dielectric layer formed on a surface and a solid electrolyte layer provided on the dielectric layer, the second layer includes an electrode lead-out layer, the valve metal base body is exposed on the first end surface of the resin molded body, the electrode lead-out layer is exposed on the second end surface of the resin molded body, the first external electrode is connected to the valve metal base body, the second external electrode is connected to the electrode lead-out layer, a dummy layer that does not contribute to capacitor capacitance is provided on one of principal surfaces in a stacking direction of the element multilayer body, and the insulating substrate is disposed at a position adjacent to the dummy layer”.

### SUMMARY

One aspect of the present disclosure relates to a solid electrolytic capacitor. The solid electrolytic capacitor includes: a capacitor element including an anode part and a cathode part; a substrate that supports the capacitor element; a sealing body that seals the capacitor element; a first external electrode electrically connected to the anode part; a second external electrode electrically connected to the cathode part; and an adhesive layer disposed between the capacitor element and a first surface of the substrate. At an interface between the first surface and the adhesive layer, a maximum height Rz1 of surface roughness of the first surface is 5 μm or more, and a maximum height Rz2 of surface roughness of the adhesive layer is 3 μm or more.

Another aspect of the present disclosure relates to a method for manufacturing the solid electrolytic capacitor. The manufacturing method includes: a step of preparing the capacitor element; a step of preparing a substrate for supporting the capacitor element; a step of applying an adhesive to a first surface of the substrate, the adhesive being to be the adhesive layer; and a step of placing the capacitor element on the substrate via the adhesive. A maximum height Rz3 of surface roughness of the first surface of the substrate prepared in the step of preparing the substrate is 10 μm or more.

The fluctuation in equivalent series resistance (ESR) in a case where the solid electrolytic capacitor including the substrate is exposed to a high temperature can be reduced.

### BRIEF DESCRIPTION OF THE DRAWINGS

FIG. 1 is a schematic cross-sectional view illustrating a solid electrolytic capacitor according to an exemplary embodiment of the present disclosure;

FIG. 2 is a roughness curve of a first surface of a substrate according to the exemplary embodiment of the present disclosure; and

FIG. 3 is an example of a cross-sectional image of solid electrolytic capacitor E1 by a scanning electron microscope (SEM).

### DETAILED DESCRIPTIONS OF EMBODIMENTS

The problems of the conventional technology are briefly explained below.

As a substrate of the solid electrolytic capacitor, for example, an insulating substrate, a metal substrate, or a multilayer substrate (such as a printed circuit board) on which a wiring pattern is formed is used. The substrate is a plate-like body including an insulating layer formed of an organic material such as an insulating resin. Therefore, in the substrate including the insulating layer, water vapor easily transmits. When a water vapor transmission rate of the substrate is high, moisture intrudes into the inside, and in a case where the solid electrolytic capacitor is exposed to a high temperature by a reflow treatment or the like, a gas is generated inside and the volume expands. Since stress due to the expansion is applied to the constituent elements in the capacitor, the constituent elements are damaged and the equivalent series resistance (ESR) fluctuates.

Hereinafter, exemplary embodiments of the present disclosure will be described with reference to examples, but the present disclosure is not limited to the examples described below. In the following description, specific numerical values, materials, and the like may be exemplified, but other numerical values, materials, and the like may be applied as long as the effect of the present disclosure can be obtained. Note that constituent elements of known capacitors may be applied to constituent elements other than the portions characteristic of the present disclosure. The term, a “range from numerical value A to numerical value B”, herein means that numerical value A and numerical value B are included in the range. In a case where a plurality of materials is presented as examples, one kind may be selected among the materials to be used solely, or two or more kinds may be used in combination.

### (Solid Electrolytic Capacitor)

In the solid electrolytic capacitor including the substrate, when the water vapor transmission rate of the substrate is high, moisture easily enters the inside. Moisture that has entered the inside is vaporized and expanded when the solid electrolytic capacitor is exposed to a high temperature in a reflow treatment or the like, so that stress due to expansion is likely to be applied to internal constituent elements. When stress is applied to a capacitor element, a sealing body, a lead, or the like, cracks are generated or peeling occurs, resistance increases, and ESR of the solid electrolytic capacitor increases. Furthermore, since it is difficult to control the degree of stress accompanying expansion of the intruded moisture, a portion to which stress is applied, and the like, variation in the fluctuation range of the ESR among individuals tends to be large.

In view of the above, a solid electrolytic capacitor (Hereinafter, it is also referred to as “capacitor (C)”.) according to an exemplary embodiment of the present disclosure includes: a capacitor element including an anode part and a cathode part; a substrate that supports the capacitor element; a sealing body that seals the capacitor element; a first external electrode electrically connected to the anode part; a second external electrode electrically connected to the cathode part; and an adhesive layer disposed between the capacitor element and a first surface of the substrate. Here, at the interface between the first surface and the adhesive layer, the maximum height Rz1 of the surface roughness of the first surface is 5 μm or more, and the maximum height Rz2 of the surface roughness of the adhesive layer is 3 μm or more.

In a case where the maximum height Rz1 of the surface roughness of the first surface is 5 μm or more and the maximum height Rz2 of the surface roughness of the adhesive layer is 3 μm or more at the interface between the first surface and the adhesive layer, it can be said that the surface of the adhesive layer facing the first surface of the substrate has a shape substantially along the irregularity shape of the first surface. Therefore, it can be said that the adhesive layer penetrates into the recess of the first surface and is in close contact with the first surface. As a result, the amount of water vapor passing through the first surface of the substrate can be reduced, and fluctuation (particularly increase) in ESR of capacitor (C) in the case of being exposed to a high temperature such as a reflow treatment can be reduced. In the present disclosure, the entry of moisture into capacitor (C) itself is reduced, so that the variation in the fluctuation range of the ESR among the solid electrolytic capacitors can also be reduced.

Rz1 may be 6 μm or more, or 7 μm or more. An upper limit of Rz1 is not particularly limited, but is, for example, less than or equal to 100 μm, or may be less than or equal to 50 μm.

Rz1 can be obtained in the following manner by cutting capacitor (C) and capturing a cross-sectional image using a scanning electron microscope (SEM). The cross-sectional image is formed in parallel with the stacking direction of the substrate, the adhesive layer, and the capacitor element. The cross-sectional image is captured, for example, at a magnification of 300 times or more. A length of the first surface of the cross-sectional image in a plane direction is 200 μm or more. From the cross-sectional image, a “roughness curve” obtained by removing an undulation curve from a cross-sectional curve of the first surface can be calculated. In a case where the adhesive layer is sufficiently in close contact with the first surface, the “roughness curve” of the interface between the first surface and the adhesive layer can be calculated from the cross-sectional image. Then, Rz1 can be calculated from the roughness curve. A cross-sectional image of capacitor (C) to be measured is measured at a plurality of locations (for example, five or more locations), Rz1 is calculated from a roughness curve in each cross-sectional image, and an average value of all calculated Rz1 is calculated.

Similarly to Rz1, Rz2 can be obtained using a cross-sectional image of capacitor (C) captured by the SEM. From the cross-sectional image, the “roughness curve” of the surface of the adhesive layer or the interface between the first surface and the adhesive layer can be calculated. Rz2 is calculated from the roughness curve. A cross-sectional image of capacitor (C) to be measured is measured at a plurality of locations (for example, five or more locations), Rz2 is calculated from a roughness curve in each cross-sectional image, and an average value of all calculated Rz2 is calculated.

### (Adhesive Layer)

The adhesive layer has an action of adhering the capacitor element to the substrate. The adhesive layer is preferably formed of a curable adhesive. The curable adhesive contains a curable resin. The curable resin may be an insulating resin. The adhesive may be conductive, non-conductive or insulating.

The conductive adhesive forms a conductive adhesive layer. The conductive adhesive or adhesive layer includes conductive filler particles. As the conductive filler particles, metal particles such as silver particles, conductive carbon particles, and the like can be used.

The non-conductive (insulating) adhesive forms a non-conductive (insulating) adhesive layer. The non-conductive (insulating) adhesive or adhesive layer contains insulating filler particles. As the insulating filler particles, ceramic particles can be used.

The insulating resin may contain, for example, at least one selected from the group consisting of an epoxy resin, an acrylic resin, a silicone resin, a polyamide resin, and a polyimide resin.

At the interface between the first surface and the adhesive layer, the maximum height Rz2 of the surface roughness of the adhesive layer may be 3 μm or more, but Rz2 may be 6 μm or more, or 7 μm or more. An upper limit of Rz2 is not particularly limited, but is, for example, less than or equal to 100 μm, and may be less than or equal to 50 μm.

Rz2 may be 50% or more, 80% or more, or 90% or more of Rz1. In this case, it can be said that the surface of the adhesive layer at a side close to the first surface has a shape substantially along the shape of the first surface. Furthermore, it can be said that the adhesive layer penetrates deep into the recess of the first surface and is in close contact with the first surface.

The average void ratio of the adhesive layer between the capacitor element and the first surface may be less than or equal to 50%, less than or equal to 20%, or less than or equal to 10%. In this case, it can be said that the surface of the adhesive layer at a side close to the first surface has a shape substantially along the shape of the first surface. Furthermore, it can be said that the adhesive layer penetrates deep into the recess of the first surface and is in close contact with the first surface.

Average void ratio (Rpav) of the adhesive layer can be determined using a cross-sectional image of capacitor (C) used for determining Rz1. When the cross-sectional image is subjected to binarization processing, a region between the capacitor element and the first surface can be divided into the adhesive layer and a void. An area Sa of the adhesive layer and an area Sp of the void are obtained, and a ratio (%) of Sp to the total of Sa and Sp is calculated as a void ratio Rp. A cross-sectional image of capacitor (C) to be measured is measured at a plurality of locations (for example, five or more locations), Rp is calculated in each cross-sectional image, and average value Rpav of all calculated Rp is calculated.

A proportion of the close contact region where the capacitor element and the first surface are in close contact with each other in an area of the first surface of the substrate is preferably 20% or more, more preferably 50% or more, still more preferably 80% or more, even more preferably 90% or more. As a proportion of an area of the close contact region increases, an amount of water vapor passing through the first surface of the substrate can be more remarkably reduced.

Here, the close contact region can be specified by capturing an appearance photograph of a second surface (that is, an outer surface) opposite to the first surface of the substrate, and performing binarization processing on the appearance photograph. The voids are observed through the outer surface of a region other than the close contact region. On the other hand, since no void is observed through the outer surface of the close contact region, the outer surface is observed in a dark color with relatively low brightness. Therefore, in the appearance photograph subjected to the binarization processing, it is possible to easily distinguish between the close contact region and a region other than the close contact region.

Specifically, a proportion of an area of the close contact region to an area of the first surface of the substrate may be calculated as a proportion of an area of the close contact region to an area of a portion exposed as the outer surface (a portion not covered with the external electrode) in the second surface of the substrate.

Note that, in the close contact region, a void ratio of the adhesive layer between the capacitor element and the first surface is estimated to be approximately less than or equal to 10%.

Rz2 is preferably 30% or more of average thickness Tav of the adhesive layer. That is, Rz2 is preferably a considerably large value with respect to the thickness of the adhesive layer. In this case, in other words, it can be said that the adhesive layer is considerably thin with respect to Rz2. Rz2 may be 50% or more, 80% or more, 90% or more, or 100% or more of average thickness Tav of the adhesive layer.

Average thickness Tav of the adhesive layer can be determined in the following manner using a cross-sectional image of capacitor (C) used for determining Rz1. In the cross-sectional image, the thickness of the adhesive layer is calculated at intervals of 20 μm along a surface direction of the first surface on the basis of the interface between the capacitor element and the adhesive layer. Tav is calculated by averaging a plurality of calculated values (thicknesses) obtained.

In a case where the adhesive layer contains the insulating resin and the filler particles, the filler particles have an action of reducing an amount of water vapor passing through the first surface of the substrate. From the viewpoint of enhancing the action, the size of the filler particles contained in the adhesive layer is preferably a size that allows the filler particles to penetrate deep into the recess of the first surface. An average particle diameter of the filler particles contained in the adhesive layer is, for example, less than or equal to 10 μm, and may be less than or equal to 5 μm.

The average particle size of the filler particles is calculated from the cross-sectional image of capacitor (C) used for determining Rz1. Specifically, any 100 filler particles dispersed in the adhesive layer are selected, and their maximum diameters are determined. The average particle diameter of the filler particles is calculated by averaging all the maximum diameters obtained.

In a case where the filler particles penetrate deep into the recess on the first surface, the filler particles may be present at a distance of 80% or more, more preferably 100% or more of Tav from the interface between the capacitor element and the adhesive layer.

The content of the filler particles in the adhesive layer is, for example, preferably 5 vol % or more and 90 vol % or less, and more preferably 30 vol % or more and 90 vol % or less from the viewpoint of easily penetrating the adhesive layer deep into the recess of the first surface.

The content of the filler particles in the adhesive layer can be determined using a cross-sectional image of capacitor (C) used for determining Rz1. When the region of the adhesive layer in the cross-sectional image is subjected to binarization processing, the region of the adhesive layer can be divided into the insulating resin and the filler particles. An area Sr of the insulating resin and an area Sf of the filler particles are determined, respectively, and a ratio (%) of Sf to the total of Sr and Sf is calculated as the content. The cross-sectional image of capacitor (C) to be measured may be measured at a plurality of locations (for example, five or more locations), the content may be calculated in each cross-sectional image, and the average value of all the calculated contents may be calculated.

Capacitor (C) may include two or more stacked capacitor elements. In the present disclosure, entry of moisture into capacitor (C) is reduced, so that application of stress to the constituent elements is suppressed even in a case where capacitor (C) is exposed to a high temperature. Therefore, even in a case where capacitor (C) includes two or more stacked capacitor elements, electrical connection between the capacitor elements and the external electrodes is easily secured in the case of being exposed to a high temperature, and high capacitance is easily maintained.

### (Substrate)

The substrate includes the first surface in contact with the adhesive layer. The capacitor element is mounted on the first surface of the substrate via the adhesive layer. The substrate includes at least one insulating layer. The first surface is usually a surface of the insulating layer. The substrate including the insulating layer is also referred to as an insulating substrate.

The insulating layer is formed of an insulating resin, and may contain ceramic particles, glass fibers, and the like. Examples of the ceramic particles include silica, alumina, glass, talc, and mica. The glass fibers may be included in the form of a woven or non-woven fabric (for example, glass cloth). The ceramic particles and the glass fiber have an action of preventing entry of moisture into capacitor (C). Therefore, the fluctuation in ESR of capacitor (C) in the case of being exposed to a high temperature is further reduced.

A content ratio of glass fiber in the insulating layer may be, for example, 50 parts by mass or more and 1000 parts by mass or less, or 60 parts by mass or more and 700 parts by mass or less with respect to 100 parts by mass of the insulating resin.

A content ratio of the ceramic particles in the insulating layer may be, for example, 5 parts by mass or more and 300 parts by mass or less, or 10 parts by mass or more and 250 parts by mass or less with respect to 100 parts by mass of the insulating resin.

The insulating resin may contain, for example, at least one selected from the group consisting of an epoxy resin, a polyimide resin, a phenol resin, and a fluororesin. Specific examples of the substrate containing such an insulating resin include a glass epoxy substrate, a paper phenol substrate, a glass polyimide substrate, and a fluorine substrate. The glass epoxy substrate and the glass polyimide substrate include glass fibers. Such a substrate is easily available and relatively inexpensive, and has a large action of reducing the fluctuation in ESR of capacitor (C) in the case of being exposed to a high temperature.

A thickness of the substrate may be 50 μm or more and 500 μm or less. In this case, the strength of the substrate suitable for holding the capacitor element can be obtained. Furthermore, the thickness of capacitor (C) can be made relatively small.

The substrate may include at least one metal layer. The substrate may include one metal layer and two insulating layers sandwiching the metal layer and adhering to the surface of the metal layer. The metal layer can further reduce entry of moisture into capacitor (C). The metal layer may be laminated with the insulating layer, or may be formed on the insulating layer by a gas phase method such as vapor deposition.

In a case where the substrate includes the metal layer, a thickness of the metal layer may be 5 μm or more and 100 μm or less. The content of the metal layer in the entire substrate may be 1 mass % or more and 55 mass % or less. As a result, entry of moisture into capacitor (C) can be reduced, and a thin substrate can be obtained. The metal layer may be at least one selected from the group consisting of a copper foil and a copper alloy foil.

The thickness of the substrate or the metal layer is determined by selecting any five or more locations of the substrate or the metal layer, measuring thicknesses, and averaging the thicknesses.

### (Method for Manufacturing Capacitor (C))

Capacitor (C) includes a step (i) of preparing at least one capacitor element, a step (ii) of preparing a substrate for supporting the capacitor element, a step (iii) of applying an adhesive to a first surface of the substrate, the adhesive being to be the adhesive layer, and a step (iv) of placing the capacitor element on the substrate via the adhesive.

The maximum height Rz3 of the surface roughness of the first surface of the substrate prepared in the step (ii) is preferably 10 μm or more, and may be 30 μm or more. It can also be said that the first surface of the substrate is roughened. As a result, it is considered that when the adhesive is applied to the first surface in the step (iii), the unevenness of the first surface and the adhesive are combined, the adhesive permeates deep into the recess, and an adhesive layer having high adhesion to the first surface is formed.

After the step of applying the adhesive to the substrate, the adhesive may be allowed to permeate the first surface (specifically, irregularities on the first surface) of the substrate under reduced pressure. Since the air retained in the irregularities of the first surface is at least partially removed under reduced pressure, the adhesive smoothly permeates the first surface having the large maximum height Rz3. The term “under reduced pressure” means, for example, under a pressure of less than or equal to 0.1 MPa, and further under a pressure of less than or equal to 0.07 MPa.

The viscosity of the adhesive at 25° C. is, for example, 5 Pa·s or more and 75 Pa·s or less, and may be less than or equal to 50 Pas. As the viscosity at 25° C. is lower, the adhesive smoothly permeates the first surface having the large maximum height Rz3. Here, the viscosity of the adhesive at 25° C. refers to a viscosity measured using an E-type viscometer (cone plate).

As described above, if the adhesive is curable, the cured substrate (that is, the substrate on which the adhesive layer is formed) after steps (i) to (iii) has low water vapor transmission rate. The water vapor transmission rate of the substrate on which the adhesive layer is formed may be, for example, 30 g/m²/day or less, or may be 25 g/m²/day or less. When the water vapor transmission rate is in such a range, entry of moisture through the substrate can be remarkably reduced, and fluctuation in ESR in a case where capacitor (C) is exposed to a high temperature can be further reduced. A lower limit of the water vapor transmission rate of the substrate is preferably as low as possible, but it is difficult to completely set the water vapor transmission rate to 0 g/m²/day, and may be, for example, 0.1 g/m²/day or more.

The water vapor transmission rate of the substrate can be measured in accordance with JIS Z 0208:1976 “Test method for moisture permeability of moisture-proof packaging material (cup method)”. The test is performed under the temperature and humidity conditions of a temperature of 85° C. and a relative humidity of 85%. However, as a measurement sample of the “substrate on which the adhesive layer is formed” for measuring the water vapor transmission rate, a wide substrate in a state where the capacitor element is not placed is used.

Since the water vapor transmission rate of the substrate (and a moisture absorption amount of capacitor (C)) can be controlled by the state of an interface between the first surface and the adhesive layer, for example, the surface roughness Rz1 of the first surface, the moisture absorption amount of capacitor (C) can be reduced even in a case where the water vapor transmission rate of the constituent material of the substrate itself is high (for example, in a case where the water vapor transmission rate is more than 10 g/m²/day,).

### (Capacitor Element)

The capacitor element includes an anode part and a cathode part. In order to electrically separate the anode part and the cathode part, a separation layer that is insulative may be provided. Capacitor (C) includes at least one capacitor element, and may include two or more capacitor elements. The two or more capacitor elements may be stacked, for example.

### (Anode Part)

The anode part is usually at least a part of an anode body. The anode body may include a first portion and a second portion. The first portion includes one end portion (first end portion) of the anode body. The second portion includes the other end portion (second end portion). The cathode part is formed in the second portion. The anode part may be at least a part of the first portion.

The anode body may be a foil (anode foil) of an anode material or a sintered body of particles of an anode material. The anode material may include a valve metal, an alloy including the valve metal, an intermetallic compound including the valve metal, and the like. The valve metal may be aluminum, tantalum, niobium, titanium, or the like.

In a case where the anode foil is used, a porous part may be formed on a surface of at least the second portion of the anode foil. In this case, the anode foil includes a core part and the porous part formed on a surface of the core part. The porous part may be formed, for example, by roughening the surface of at least the second portion of the anode foil by etching. The etching may be performed by a known method, and for example, electrolytic etching is performed.

After a masking member is disposed on a surface of the first portion, the second portion of the anode foil may be roughened, or the entire surface of the anode foil may be subjected to a roughening treatment. In the former case, the porous part is not formed on the surface of the first portion. In the latter case, the porous parts are formed on the surfaces of the first portion and the second portion. The masking member is preferably an insulator such as resin. The masking member may be removed before the formation of the solid electrolyte layer.

In a case where the surface of the first portion includes the porous part, at least a part thereof may be removed in advance or compressed. This makes it possible to suppress a decrease in the reliability of capacitor (C) due to the intrusion of air through the porous part.

In a case where a plurality of capacitor elements are stacked, the end surfaces of the plurality of first end portions may be exposed from the outer surface of the sealing body to be electrically connected to the first external electrode. In a case where capacitor (C) has a substantially rectangular parallelepiped shape, one surface (for example, the bottom surface) may correspond to the second surface of the substrate, and the remaining five surfaces may correspond to the outer surfaces of the sealing body.

### (Dielectric Layer)

The dielectric layer can be formed by anodizing at least the second portion of the anode body. The anodization (chemical conversion treatment) is performed, for example, by immersing the anode body in an anodizing solution and applying a voltage between the anode body as an anode and a cathode immersed in the anodizing solution.

The dielectric layer contains an oxide of a valve metal. In a case where aluminum is used as the valve metal, the dielectric layer contains aluminum oxide. The dielectric layer is formed at least on the surface of the second portion where the porous part is formed (including an inner wall surface of the pore of the porous part).

Note that the method for forming the dielectric layer is not limited as long as the insulating layer functioning as a dielectric material can be formed on the surface of the second portion. The dielectric layer may also be formed on the surface of the first portion.

### (Cathode Part)

The cathode part is formed on the second portion of the anode body including the dielectric layer. The cathode part may cover a surface of the separation layer at a side close to the second portion. The cathode part includes, for example, a solid electrolyte layer covering at least a part of the dielectric layer, and a cathode lead-out layer covering at least a part of the solid electrolyte layer. The cathode part is formed by forming the solid electrolyte to cover at least a part of the dielectric layer and forming the cathode lead-out layer to cover at least a part of the solid electrolyte layer.

### (Solid Electrolyte Layer)

The solid electrolyte layer contains a conductive polymer (such as a conjugated polymer, or a dopant), for example. The solid electrolyte layer may contain a manganese compound.

As the conjugated polymer, a x-conjugated polymer (polypyrrole, polythiophene, polyaniline, derivatives thereof, and the like) may be used, for example. For example, the polythiophene derivative includes poly (3,4-ethylenedioxythiophene) (PEDOT) and the like.

As the dopant, polystyrene sulfonic acid (PSS) or the like may be used, and naphthalene sulfonic acid, toluene sulfonic acid or the like may be used.

The solid electrolyte layer can be formed by polymerizing a precursor of a conjugated polymer (such as a monomer or an oligomer) and a dopant (such as naphthalenesulfonic acid or toluenesulfonic acid) on the dielectric layer using at least one of chemical polymerization and electrolytic polymerization, for example.

The solid electrolyte layer may be formed by attaching, to the dielectric layer, a solution in which the conjugated polymer and the dopant are dissolved or a dispersion liquid in which the conjugated polymer and the dopant are dispersed, and drying the dielectric layer. As the dispersion medium (solvent), for example, water, an organic solvent, or a mixture thereof can be used.

### (Cathode Lead-Out Layer)

The cathode lead-out layer includes, for example, a conductive layer that is in contact with the solid electrolyte layer and covers at least a part of the solid electrolyte layer. The conductive layer includes at least a first layer covering at least a part of the solid electrolyte layer. The cathode lead-out layer may include the first layer and a second layer covering at least a part of the first layer. The cathode lead-out layer may include a layer containing conductive carbon as a first layer and a metal layer (for example, metal foil) as a second layer. The conductive carbon contained in the first layer may be, for example, graphite (artificial graphite, natural graphite, etc.).

The first layer may be constituted by a metal foil. The metal foil as the first layer may be formed of, for example, an aluminum (Al) foil, a copper (Cu) foil, a valve metal (aluminum, tantalum, niobium, and the like) or an alloy thereof. The surface of the metal foil may be roughened. The surface of the metal foil may include an anodization coating film. The metal foil may include a coating film of a dissimilar metal or a nonmetal different from the metal constituting the metal foil itself as the second layer. The dissimilar metal or the nonmetal may be, for example, a metal such as titanium (Ti) or nickel (Ni), or a nonmetal such as carbon (conductive carbon or the like). The metal foil may be an Al foil having a surface on which Ni is deposited. The metal foil may include a Ti, TiC, TiO, C (carbon) film, or the like.

The second layer may be a layer containing metal powder. For example, a conductive adhesive may be used for the second layer. As the conductive adhesive, a metal paste layer containing metal powder and a resin may be used. The metal paste layer may be a silver paste layer containing silver particles and a resin. As the resin, a thermosetting resin such as an imide resin or an epoxy resin is preferably used.

The metal foil may be attached to the solid electrolyte layer or the first layer via a layer containing conductive carbon, a metal paste layer, or the like.

When the cathode part includes the metal foil, an end surface of the metal foil is exposed from an outer surface of the sealing body, and can be easily electrically connected to the second external electrode. In a case where a plurality of capacitor elements are stacked, a metal foil may be provided on at least one of the plurality of capacitor elements, or a metal foil may be interposed between the capacitor elements adjacent each other.

### (Separation Layer)

The separation layer is formed before the cathode part is formed. The separation layer may be provided close to the cathode part while covering at least a part of the surface of the first portion. From the viewpoint of suppressing the entry of air into capacitor (C), the separation layer may be in close contact with the first portion and the sealing body. The separation layer may be disposed on the first portion with the dielectric layer interposed therebetween. Such a separation layer is provided after formation of the dielectric layer. If necessary, the separation layer may be provided before formation of the dielectric layer.

The separation layer may be provided by bonding an insulation member in the shape of a sheet (resin tape or the like) to the first portion, for example. The separation layer may be formed as an insulating member in close contact with the first portion by applying or impregnating at least a part of the first portion with the liquid resin. The application or the impregnation of the liquid resin to the first portion and the sticking of the sheet-like insulating member may be used in combination.

### (Spacer)

Capacitor (C) may include a spacer. The spacer is disposed, for example, at least one of between adjacent anode parts and between end portions of adjacent cathode parts of the plurality of stacked capacitor elements. The spacer may be conductive (made of metal or the like) or insulating. In a case where the insulating spacer is used, the spacer may be exposed from an outer surface of the sealing body together with the end surface of the anode part or the cathode part. The insulating spacer can be formed of, for example, a thermoplastic resin or a curable resin.

### (Sealing Body)

The capacitor element (or the plurality of stacked capacitor elements) is sealed by being covered with a sealing body. The capacitor element may be sealed such that at least one end surface of the anode part and the cathode part is exposed from the outer surface of the sealing body. After the sealing, the sealing body may be partially removed to expose at least one end surface of the anode part and the cathode part from the outer surface of the sealing body.

The sealing body preferably contains, for example, a cured product of a thermosetting resin. The sealing body may contain a filler, a curing agent, a polymerization initiator, a catalyst, and the like. The sealing body may be formed using a molding technique such as injection molding. The sealing body may be formed by molding a composition containing a thermosetting resin using a predetermined mold so as to cover the capacitor element supported on the substrate.

### (Contact Layer)

At least one of the end surfaces of the anode part and the cathode part exposed from the sealing body may be connected to the external electrode via a contact layer. The contact layer may be formed of, for example, an electroless Ni plating layer, an electrolytic Ni plating layer, or a Ni plating layer and an electroless Ag plating layer covering the Ni plating layer. The contact layer may be formed by a sputtering method, a vacuum deposition method, a chemical vapor deposition (CVD) method, a cold spraying method, or a thermal spraying method. In a case where the contact layer is provided, the electrical connection between the end surface of the anode part or the cathode part and the external electrode can be further ensured by the contact layer.

### (External Electrode)

The external electrode includes a first external electrode connected to the anode part of the capacitor element and a second external electrode connected to the cathode part. Each external electrode may include a metal layer. The metal layer is a plating layer, for example. The metal layer contains at least one selected from the group consisting of nickel (Ni), copper (Cu), zinc (Zn), tin (Sn), silver (Ag), and gold (Au), for example. To form the metal layer, a film forming technique, such as an electrolytic plating method, an electroless plating method, a sputtering method, a vacuum vapor deposition method, a chemical vapor deposition (CVD) method, a cold spraying method, or a thermal spraying method, may be used, for example.

Each external electrode may have a stacked structure of a Ni layer and a tin layer, for example. Each external electrode includes an outer surface that is preferably made of a metal having excellent wettability with the solder. Examples of such a metal include tin (Sn), gold (Au), silver (Ag), and palladium (Pd).

Each external electrode may include a stacked structure of a conductive paste layer and a plating layer, for example. A stacked structure of a Ni layer and a Sn layer (Ni and Sn plating layer or the like) may be adopted as the plating layer in terms of excellent wettability with solder.

### (Conductive Paste Layer)

The conductive paste layer may be formed covering the end surface of at least one of the anode part and the cathode part of the capacitor element or the plurality of capacitor elements. The conductive paste layer may be formed so as to cover the end surface with the contact layer interposed therebetween. The conductive paste layer may be formed so as to cover not only the end surface of the anode part or the cathode part but also the surface (side surface or the like) of the sealing body from which the end surface is exposed.

The conductive paste layer can be formed by applying a conductive paste containing conductive particles and a resin material to the surface of the sealing body where the end surface of the anode part or the cathode part is exposed, and drying the conductive paste. As the conductive particles, metal particles such as those of silver or copper, or particles of a conductive inorganic material such as those of carbon may be used, for example.

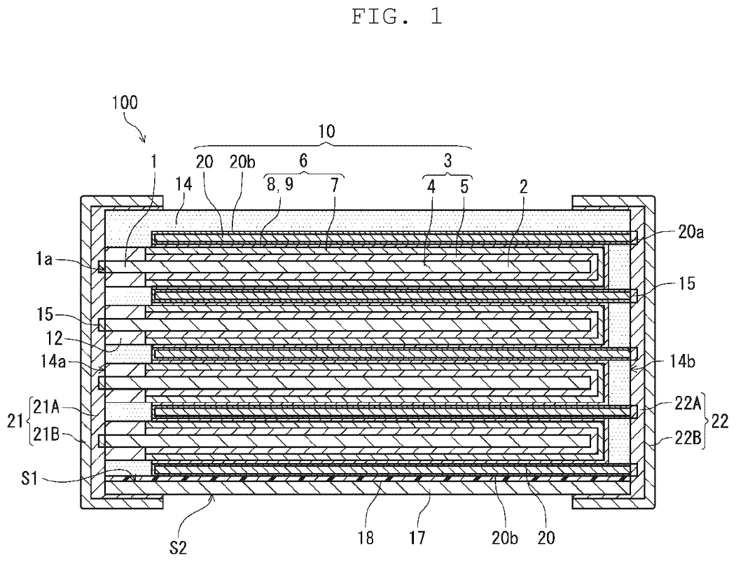

FIG. 1 is a cross-sectional view schematically illustrating a structure of capacitor (C) according to an exemplary embodiment of the present disclosure. As illustrated in FIG. 1, solid electrolytic capacitor 100 includes a plurality of stacked capacitor elements 10, sealing body 14 that seals capacitor elements 10, first external electrode 21, and second external electrode 22. In the illustrated example, the plurality of stacked capacitor elements 10 are supported by substrate 17 having an insulating property. Adhesive layer 18 is interposed between substrate 17 and capacitor element 10 closest to substrate 17. The surface of substrate 17 on which adhesive layer 18 is formed is first surface S1, and the opposite surface (outer surface) is second surface S2.

Although it cannot be determined from FIG. 1, actually, first surface S1 of substrate 17 is roughened, and at an interface between first surface S1 and adhesive layer 18, adhesive layer 18 enters a recess of first surface S1 and is in close contact with first surface S1. As a result, entry of moisture into solid electrolytic capacitor 100 through substrate 17 is suppressed, and the moisture absorption amount of the solid electrolytic capacitor is reduced.

Each capacitor element 10 includes anode body 3 constituting an anode part, and cathode part 6. Anode body 3 is anode foil, for example. Anode body 3 includes core part 4 and porous part 5 formed in a surface of core part 4 (a surface layer of anode body 3). Porous part 5 has a surface that is at least partially provided with a dielectric layer (not illustrated). Cathode part 6 is provided covering at least partially cover the dielectric layer. Cathode part 6 includes solid electrolyte layer 7 and a cathode lead-out layer.

Capacitor element 10 has one end portion (first end portion) from which anode body 3 is exposed without being covered with cathode part 6. Capacitor element 10 has the other end portion (second end portion) covered with cathode part 6. Anode body 3 includes a portion covered with cathode part 6 (especially, solid electrolyte layer 7) that is referred to as second portion 2, and a portion other than second portion 2 is referred to as first portion 1. First portion 1 is not covered with cathode part 6 of anode body 3. First portion 1 has an end portion serving as the first end portion, and second part 2 has an end portion serving as the second end portion.

In the illustrated example, second part 2 includes core 4 and porous part 5 formed in a surface of core 4. First part 1 may have a surface with or without porous part 5. The dielectric layer is formed along a surface of porous part 5 formed at least in second part 2.

The dielectric layer has a surface in an uneven shape corresponding to a shape of a surface of anode body 3. Solid electrolyte layer 7 may be formed to fill the unevenness of the dielectric layer. The cathode lead-out layer may include, for example, first layer 8 such as a carbon layer covering at least a part of solid electrolyte layer 7, and metal foil 20 as a second layer covering at least a part of first layer 8.

Metal foil 20 is interposed between second portions 2 of adjacent capacitor elements 10 in the stacking direction. Metal foil 20 constitutes a part of cathode part 6 of capacitor element 10. Metal foil 20 includes carbon layer 20b on a surface thereof. Conductive adhesive 9 may be interposed between carbon layer 20b and capacitor element 10. Conductive adhesive 9 contains, for example, carbon or silver.

Insulating separation layer (or insulating member) 12 may be formed covering a surface of anode body 3 at least in a part adjacent to cathode part 6 in a region of anode body 3, the region being without facing cathode part 6. This configuration restricts contact between cathode part 6 and an exposed portion (first portion 1) of anode body 3. Separation layer 12 is an insulating resin layer, for example.

Sealing body 14 has a substantially rectangular parallelepiped outer shape, and solid electrolytic capacitor 100 also has a substantially rectangular parallelepiped outer shape. In the illustrated example, sealing body 14 includes first outer surface 14a and second outer surface 14b opposite to the first outer surface 14a. Anode body 3 being the anode part of each capacitor element 10 includes the first end portion with end surface 1a exposed at first outer surface 14a. End surface 20a of metal foil 20 constituting cathode part 6 is exposed from the sealing body at second outer surface 14b.

End surface 20a and second outer surface 14b of metal foil 20 exposed from sealing body 14 are covered with second external electrode 22. End surface 20a of metal foil 20 is provided with contact layer 15 covering end surface 20a. Second external electrode 22 is electrically connected to end surface 20a of metal foil 20 constituting cathode part 6 via contact layer 15.

End surfaces 1a and first outer surfaces 14a of the first end portions of the plurality of anode bodies 3 exposed from sealing body 14 are covered with first external electrode 21. End surface 1a of each anode body 3 is provided with contact layer 15 covering end surface 1a. In the illustrated example, the end surface of separation layer 12 is also exposed from first outer surface 14a of sealing body 14, and this exposed end surface is also covered with first external electrode 21. First external electrode 21 is electrically connected to end surface 1a of anode body 3 via contact layer 15.

First external electrode 21 includes, for example, conductive paste layer 21A such as a silver paste layer, and Ni and Sn plating layer 21B covering conductive paste layer 21A. Similarly, second external electrode 22 includes, for example, conductive paste layer 22A such as a silver paste layer, and Ni and Sn plating layer 22B covering conductive paste layer 22A.

First external electrode 21 covers entire first outer surface 14a of sealing body 14, and also covers a part of each of a third outer surface perpendicular to first outer surface 14a and substrate 17 on a side of first outer surface 14a. Similarly, second external electrode 22 covers entire second outer surface 14b, and also covers a part of each of third outer surface 14c perpendicular to second outer surface 14b and substrate 17 on a side of second outer surface 14b. With such a configuration, adhesion can be further enhanced both between first external electrode 21 and first outer surface 14a and between second external electrode 22 and second outer surface 14b. First external electrode 21 and second external electrode 22 covering a part of substrate 17 are each exposed on the bottom surface of solid electrolytic capacitor 100. These exposed portions constitute an anode terminal and a cathode terminal of solid electrolytic capacitor 100, respectively.

### (Supplementary Note)

The following techniques are disclosed by the above description.

### (Technique 1)

A solid electrolytic capacitor including:
a capacitor element including an anode part and a cathode part;
a substrate that supports the capacitor element;
a sealing body that seals the capacitor element;
a first external electrode electrically connected to the anode part;
a second external electrode electrically connected to the cathode part; and
an adhesive layer disposed between the capacitor element and a first surface of the substrate,
in which at an interface between the first surface and the adhesive layer, a maximum height Rz1 of surface roughness of the first surface is 5 μm or more, and a maximum height Rz2 of surface roughness of the adhesive layer is 3 μm or more.

### (Technique 2)

The solid electrolytic capacitor according to the technique 1, in which the maximum height Rz2 is 50% or more of the maximum height Rz1.

### (Technique 3)

The solid electrolytic capacitor according to technique 1 or 2, in which an average void ratio of the adhesive layer between the capacitor element and the first surface is less than or equal to 50%.

### (Technique 4)

The solid electrolytic capacitor according to any one of techniques 1 to 3, in which a proportion of an area of a close contact region in an area of the first surface of the substrate is 20% or more, the close contact region being a region that the capacitor element and the first surface are in close contact with each other.

### (Technique 5)

The solid electrolytic capacitor according to any one of techniques 1 to 4, in which the maximum height Rz2 is 30% or more of an average thickness Tav of the adhesive layer.

### (Technique 6)

The solid electrolytic capacitor according to any one of techniques 1 to 5, in which:
the adhesive layer includes an insulating resin and filler particles, and
the filler particles are present at a distance of 80% or more of an average thickness Tav of the adhesive layer from an interface between the capacitor element and the adhesive layer.

### (Technique 7)

The solid electrolytic capacitor according to technique 6, in which the insulating resin includes at least one selected from the group consisting of an epoxy resin, an acrylic resin, a silicone resin, a polyamide resin, and a polyimide resin.

### (Technique 8)

The solid electrolytic capacitor according to any one of techniques 1 to 7, in which two or more capacitor elements stacked on each other are provided in solid electrolytic capacitor, each of the two or more capacitor elements being the capacitor element.

### (Technique 9)

A method for manufacturing the solid electrolytic capacitor according to any one of techniques 1 to 8, the method including:
a step of preparing the capacitor element;
a step of preparing a substrate for supporting the capacitor element;
a step of applying an adhesive to a first surface of the substrate, the adhesive being to be the adhesive layer; and
a step of placing the capacitor element on the substrate via the adhesive,
in which a maximum height Rz3 of surface roughness of the first surface of the substrate prepared in the step of preparing the substrate is 10 μm or more.

### (Technique 10)

The method for manufacturing the solid electrolytic capacitor according to technique 9, further including a step of allowing the adhesive to permeate into the first surface of the substrate under reduced pressure after the step of applying the adhesive to the substrate.

### (Technique 11)

The method for manufacturing a solid electrolytic capacitor according to technique 9 or 10, in which a viscosity of the adhesive at 25° C. is 5 Pa·s or more and 75 Pa·s or less.

### EXAMPLES

The present disclosure will now be described specifically with reference to examples and comparative examples, but the present disclosure is not limited to the following examples.

The following substrates and adhesives were prepared.

### <Substrate E>

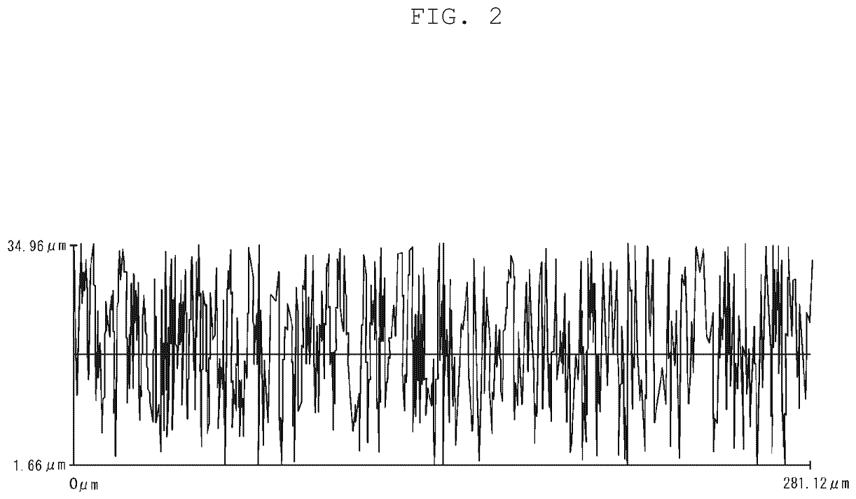

Substrate E is an insulating substrate including an insulating layer having maximum height (Rz3) of surface roughness of the first surface of 33.8 μm and a thickness of 100 μm. The insulating layer includes a nonwoven fabric of glass fiber, the content of the glass fiber is 125 parts by mass with respect to 100 parts by mass of an insulating resin, and the insulating resin is a cured product of a composition containing an epoxy resin as a main component. FIG. 2 illustrates an example of a roughness curve of the first surface of substrate E measured with a commercially available surface roughness measurement device (laser microscope VK-9510 manufactured by KEYENCE CORPORATION).

### <Adhesive A>

Adhesive A is a thermosetting insulating resin composition containing an epoxy resin as a main component and 5% by volume of filler particles having an average particle size of 0.5 μm, and has a viscosity of 25 Pa·s at 25° C.

Substrate E on which an adhesive layer was formed was produced by the following two methods, and the water vapor transmission rate (g/m²/day) of the substrate was measured by the procedure described above.

In the first method, adhesive A was applied to the first surface of substrate E by bar coating printing in an amount such that average thickness Tav of the adhesive layer was 10 μm, and then the adhesive was cured by heating at 80° C. to obtain adhesive layer 18. The water vapor transmission rate of the substrate (Hereinafter, referred to as “substrate C1”.) after formation of adhesive layer 18 was 33.2 g/m²/day.

In the second method, adhesive A was applied to the first surface of substrate E by screen printing in an amount such that average thickness Tav of the adhesive layer was 10 μm, adhesive A was allowed to sufficiently permeate into the first surface with a squeegee, and then the adhesive was cured by heating at 80° C. to obtain adhesive layer 18. The water vapor transmission rate of the substrate (Hereinafter, referred to as “substrate E1”.) after formation of adhesive layer 18 was 20.2 g/m²/day.

### <Solid Electrolytic Capacitor>

On the other hand, substrates C1 and E1 coated with the adhesive were produced by the two methods described above, seven capacitor elements were mounted on the first surfaces of substrates C1 and E1 without being cured, and a solid electrolytic capacitor as illustrated in FIG. 1 was produced in the following manner.

### (1) Preparation of Anode Body 3

Both surfaces of an aluminum foil (thickness: 100 μm) as a base material were roughened by etching to prepare anode body 3.

### (2) Formation of Dielectric Layer

The second portion of anode body 3 was immersed in an anodizing solution, and a DC voltage of 7 V was applied for 20 minutes to form a dielectric layer containing aluminum oxide.

### (3) Formation of Solid Electrolyte Layer 7

Separation layer 12 was formed at the first end portion of anode body 3. Solid electrolyte layer 7 containing a conductive polymer was formed to cover the second portion of anode body 3 on which separation layer 12 was formed.

### (4) Formation of Cathode Lead-Out Layer and Stacking of Capacitor Elements 10

Anode body 3 obtained in the above (3) was immersed in a dispersion liquid in which graphite particles were dispersed in water, taken out from the dispersion liquid, and then heated and dried to form a carbon layer as first layer 8 at least on the surface of solid electrolyte layer 7.

Seven elements on which first layer 8 was formed were stacked with metal foil 20 (aluminum foil including carbon layer 20b, thickness 20 μm) as a second layer interposed between first layers 8 of adjacent elements so that the first portions overlapped each other. At this time, metal foil 20 of the second layer was attached to adjacent first layer 8 via conductive adhesive 9. Thus, a cathode lead-out layer including first layer 8 and metal foil 20 as a second layer was formed, and capacitor element 10 including the cathode lead-out layer was completed. In each capacitor element 10, cathode part 6 includes solid electrolyte layer 7 and a cathode lead-out layer.

### (5) Sealing by Sealing Body 14

The stacked seven capacitor elements 10 obtained in the above (4) were molded with the second surface of substrate 17 exposed using a sealing material containing an epoxy resin as a main component to form sealing body 14 formed of an insulating resin around capacitor elements 10. A portion on a side surface side of sealing body 14 was cut by dicing to form first outer surface 14a and second outer surface 14b. At this time, sealing body 14 was cut so that end surface 1a of anode body 3 of each capacitor element 10 and substrate 17 were exposed from first outer surface 14a, and end surface 20a of metal foil 20 and substrate 17 were exposed from second outer surface 14b, thereby obtaining a capacitor precursor.

### (6) Formation of Contact Layer 15

Using the capacitor precursor obtained in the above (5), an electroless Ni plating layer was formed to cover end surface 1a of anode body 3 exposed from first outer surface 14a, and then an electroless Ag plating layer was formed on the electroless Ni plating layer to form contact layer 15. Similarly, an electroless Ni plating layer was formed to cover end surface 20a of metal foil 20 exposed from second outer surface 14b, and then an electroless Ag plating layer was formed on the electroless Ni plating layer to form contact layer 15.

### (7) Formation of First External Electrode 21 and Second External Electrode 22

First external electrode 21 and second external electrode 22 were formed to cover contact layer 15 formed in the above (6) and each of first outer surface 14a and second outer surface 14b.

More specifically, a conductive paste containing silver particles and a resin was applied to the outer surfaces of contact layer 15 and the sealing body, and was heated and dried to form conductive paste layers 21A and 22A, respectively. Subsequently, an electrolytic Ni plating layer and an electrolytic Sn plating layer were formed covering each of conductive paste layers 21A and 22A. In this way, each of Ni and Sn plating layers 21B and 22B was formed to obtain a solid electrolytic capacitor. A total of 20 solid electrolytic capacitors were produced for each example in the same procedure.

### (8) Evaluation

Capacitance (μF) and initial ESR (mΩ) at a frequency of 100 kHz were measured for each of 20 solid electrolytic capacitors using an LCR meter for 4-terminal measurement in an environment of 20° C.

Next, a moisture absorption test was performed according to the following procedure.

First, the solid electrolytic capacitors were allowed to stand for 192 hours in a thermostatic bath at 30° C. and 60% RH. The solid electrolytic capacitors taken out of the thermostatic bath were cooled to 25° C. As a result of measuring the mass increase amount of the 20 solid electrolytic capacitors and calculating the average value, the moisture absorption amount of the solid electrolytic capacitor using substrate C1 was 104.2 ug/piece, and the moisture absorption amount of the solid electrolytic capacitor using substrate E1 was 63.4 ug/piece. Capacitance (μF) and ESR (mΩ) of each of the 20 solid electrolytic capacitors after moisture absorption were measured in the same manner as described above.

Next, a reflow test was performed according to the following procedure.

The solid electrolytic capacitors were subjected to a reflow treatment according to IPC/JEDEC J-STD-020D. Specifically, the solid electrolytic capacitor was preheated at a holding temperature of 150° C. to 200° C. and a holding time of 180 seconds or less. The solid electrolytic capacitors after being preheated were heated at a temperature of 255° C. or higher (maximum temperature: 260° C.) for 30 seconds. At this time, heating at a maximum temperature of 260° C. was performed for 10 seconds or less. The solid electrolytic capacitors were then cooled to 25° C. over 10 minutes, and this heating and cooling were repeated 2 more times (that is, three times in total.). Capacitance (μF) and ESR (mΩ) of each of the reflowed 20 solid electrolytic capacitors were measured in the same manner as described above.

The results of the capacitance and ESR are shown in Table 1. In Table 1, E1 is an example, and C1 is a comparative example.

TABLE 1

| | C1 | | E1 | |
|---|---|---|---|---|
| | Capacitance | ESR | Capacitance | ESR |
| | (μF) | (mΩ) | (μF) | (mΩ) |
| Initial | 668.5 | 1.95 | 663.2 | 1.97 |
| After moisture absorption | 685.0 | 2.05 | 677.8 | 2.04 |
| After reflow | 670.7 | 2.60 | 671.3 | 2.19 |

In solid electrolytic capacitors C1 and E1, maximum height Rz1, maximum height Rz2, average thickness Tav of the adhesive layer, average void ratio Rpav, and ratio (Rx) of the close contact region to the area of the first surface were measured by the methods described above, and the results were as follows.

### <Solid Electrolytic Capacitor E1>

Rz1: 7.5 μm
Rz2: 7.4 μm
Tav: 7.5 μm
Rpav: 1.5%
Rx: 99.0%

### <Solid Electrolytic Capacitor C1>

Rz1: 7.5 μm
Rz2: 2.8 μm
Tav: 10.0 μm
Rpav: 15.0%
Rx: 62.0%

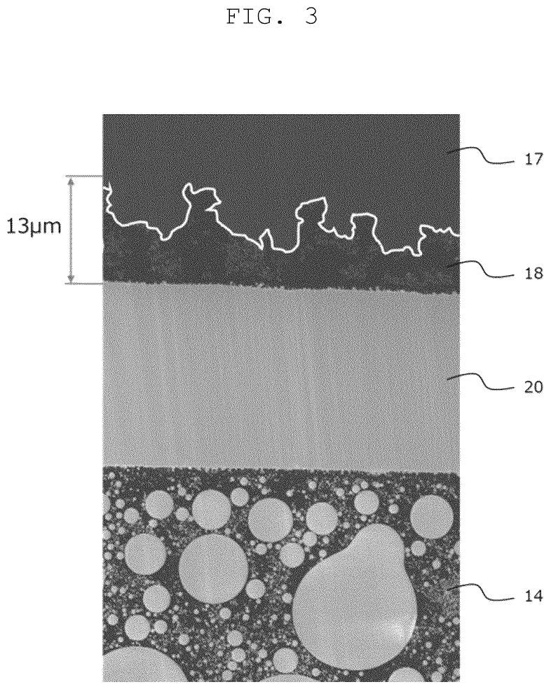

FIG. 3 illustrates a cross-sectional image (original drawing magnification: 100,000 times) of an example of solid electrolytic capacitor E1. In FIG. 3, the interface between the adhesive layer and the first surface of the substrate is emphasized by a white line. The surface of the adhesive layer on the first surface side has a shape substantially along the shape of the first surface of the substrate, and it can be seen that the adhesive layer penetrates deep into the recess of the first surface.

The solid electrolytic capacitor according to the present disclosure can suppress entry of moisture into the inside through a substrate including an insulating layer, and can suppress fluctuation in ESR in the case of being exposed to a high temperature such as a reflow treatment. Therefore, the solid electrolytic capacitor according to the present disclosure can be used for various applications requiring high reliability, and is also useful for applications requiring high heat resistance, applications used in high humidity environments, and the like. However, the application of the solid electrolytic capacitor is not limited to these.

What is claimed is:

1. A solid electrolytic capacitor comprising:
a capacitor element including an anode part and a cathode part;
a substrate that supports the capacitor element;
a sealing body that seals the capacitor element;
a first external electrode electrically connected to the anode part;
a second external electrode electrically connected to the cathode part; and
an adhesive layer disposed between the capacitor element and a first surface of the substrate, wherein:
at an interface between the first surface and the adhesive layer, a maximum height Rz1 of surface roughness of the first surface is 5 μm or more, and a maximum height Rz2 of surface roughness of the adhesive layer is 3 μm or more.

2. The solid electrolytic capacitor according to claim 1, wherein the maximum height Rz2 is 50% or more of the maximum height Rz1.

3. The solid electrolytic capacitor according to claim 1, wherein an average void ratio of the adhesive layer between the capacitor element and the first surface is less than or equal to 50%.

4. The solid electrolytic capacitor according to claim 1, wherein a proportion of an area of a close contact region in an area of the first surface of the substrate is 20% or more, the close contact region being a region that the capacitor element and the first surface are in close contact with each other.

5. The solid electrolytic capacitor according to claim 1, wherein the maximum height Rz2 is 30% or more of an average thickness Tav of the adhesive layer.

6. The solid electrolytic capacitor according to claim 1, wherein:
the adhesive layer includes an insulating resin and filler particles, and
the filler particles are present at a distance of 80% or more of an average thickness Tav of the adhesive layer from an interface between the capacitor element and the adhesive layer.

7. The solid electrolytic capacitor according to claim 6, wherein the insulating resin includes at least one selected from the group consisting of an epoxy resin, an acrylic resin, a silicone resin, a polyamide resin, and a polyimide resin.

8. The solid electrolytic capacitor according to claim 1, wherein two or more capacitor elements stacked on each other are provided in solid electrolytic capacitor, each of the two or more capacitor elements being the capacitor element.

9. A method for manufacturing the solid electrolytic capacitor according to claim 1, the method comprising:
a step of preparing the capacitor element;
a step of preparing a substrate for supporting the capacitor element;
a step of applying an adhesive to a first surface of the substrate, the adhesive being to be the adhesive layer; and
a step of placing the capacitor element on the substrate via the adhesive,
wherein a maximum height Rz3 of surface roughness of the first surface of the substrate prepared in the step of preparing the substrate is 10 μm or more.

10. The method for manufacturing the solid electrolytic capacitor according to claim 9, further comprising a step of allowing the adhesive to permeate into the first surface of the substrate under reduced pressure after the step of applying the adhesive to the substrate.

11. The method for manufacturing the solid electrolytic capacitor according to claim 9, wherein a viscosity of the adhesive at 25° C. is 5 Pa·s or more and 75 Pa·s or less.
